(19) United States
(12) Patent Application Publication
(10) Pub. No.: US 2026/0087272 A1
(43) Pub. Date: Mar. 26, 2026

(54) CONTEXTUAL LANGUAGE ASSISTANCE

(71) Applicant: Apple Inc., Cupertino, CA (US)

(72) Inventors: Paul EWERS, San Jose, CA (US); Peter BURGNER, Venice, CA (US); Michael C. FRIEDMAN, Nederland, CO (US); Christopher D. FU, Fremont, CA (US); Paulo R. JANSEN DOS REIS, San Jose, CA (US); Evan JONES, Kirkland, WA (US); Thomas J. MOORE, Northglenn, CO (US); Elena J. NATTINGER, Menlo Park, CA (US)

(21) Appl. No.: 19/323,573

(22) Filed: Sep. 9, 2025

Related U.S. Application Data
(60) Provisional application No. 63/698,354, filed on Sep. 24, 2024.

(51) Int. Cl. G06F 40/58; G10L 25/78

(52) U.S. Cl. CPC G06F 40/58; G10L 25/78

(57) ABSTRACT

Disclosed herein are example processes for providing translations of foreign language content based on context information. For example, in response to receiving language content in a foreign language and in accordance with a determination that the context in which the language content is received satisfies certain criteria, a translation of the language content is provided to a user.

### CROSS-REFERENCE TO RELATED APPLICATIONS

This application claims priority to U.S. Provisional Patent Application No. 63/698,354, entitled “CONTEXTUAL LANGUAGE ASSISTANCE,” filed on Sep. 24, 2024, the entire contents of which are hereby incorporated by reference in their entirety.

### TECHNICAL FIELD

The present disclosure generally relates to providing translations of foreign language content.

### BACKGROUND

The development of computer systems for interacting with and/or providing three-dimensional scenes has expanded significantly in recent years. Example three-dimensional scenes (e.g., environments) include physical scenes and extended reality scenes.

### SUMMARY

Example methods are disclosed herein. An example method includes: at a computer system that is in communication with one or more sensor devices: receiving language content, wherein the language content is in a first language; in response to receiving the language content, determining, based on a first set of contextual information and the language content, whether a set of one or more translation delivery criteria is satisfied for the language content; and, in accordance with a determination that the set of one or more translation delivery criteria is satisfied for the language content, delivering a translation of the language content, wherein the translation is in a second language different from the first language.

Example non-transitory computer-readable storage media are disclosed herein. An example non-transitory computer-readable storage medium stores one or more programs. The one or more programs are configured to be executed by one or more processors of a computer system that is in communication with one or more sensor devices. The one or more programs include instructions for: receiving language content, wherein the language content is in a first language; in response to receiving the language content, determining, based on a first set of contextual information and the language content, whether a set of one or more translation delivery criteria is satisfied for the language content; and, in accordance with a determination that the set of one or more translation delivery criteria is satisfied for the language content, delivering a translation of the language content, wherein the translation is in a second language different from the first language.

Example computer systems are disclosed herein. An example computer system is configured to communicate with one or more sensor devices. The computer system comprises: one or more processors; and memory storing one or more programs configured to be executed by the one or more processors, the one or more programs including instructions for: receiving language content, wherein the language content is in a first language; in response to receiving the language content, determining, based on a first set of contextual information and the language content, whether a set of one or more translation delivery criteria is satisfied for the language content; and, in accordance with a determination that the set of one or more translation delivery criteria is satisfied for the language content, delivering a translation of the language content, wherein the translation is in a second language different from the first language.

An example computer system is configured to communicate with one or more sensor devices. The computer system comprises: means for receiving language content, wherein the language content is in a first language; means for, in response to receiving the language content, determining, based on a first set of contextual information and the language content, whether a set of one or more translation delivery criteria is satisfied for the language content; and means for, in accordance with a determination that the set of one or more translation delivery criteria is satisfied for the language content, delivering a translation of the language content, wherein the translation is in a second language different from the first language.

Providing translations based on context information provides for more intuitive and efficient user-device interaction. Specifically, determining to provide a translation of detected or received foreign language content to a user based on the user's current context reduces the number of user inputs, and thus the time and amount of power, needed to obtain computer system assistance in providing relevant, useful, and desirable translations. Doing so also improves the accuracy of providing computer system assistance with translation, for instance, by providing translations only in certain contextual conditions, and thus reducing the amount of time and power spent generating and/or outputting translations for content that is not relevant, useful, and/or desirable at the time. Providing translations based on context information also makes for an improved user-device interaction by drawing the user's attention to relevant, useful, and desirable translations without distracting the user with unnecessary additional information from contextually-inappropriate translations, which in turn reduces power usage and improves battery life of the device by enabling the user to use the device more quickly and efficiently (e.g., reducing repeated and/or corrective user inputs if the device does not operate as desired).

In some examples, the computer system is a desktop computer with an associated display. In some examples, the computer system is a portable device (e.g., a notebook computer, tablet computer, or handheld device such as a smartphone). In some examples, the computer system is a personal electronic device (e.g., a wearable electronic device, such as a watch or a head-mounted device). In some examples, the computer system has a touchpad. In some examples, the computer system has one or more cameras. In some examples, the computer system has a display generation component (e.g., a display device such as a head-mounted display, a display, a projector, a touch-sensitive display (also known as a “touch screen” or “touch-screen display”), or other device or component that presents visual content to a user, for example on or in the display generation component itself or produced from the display generation component and visible elsewhere). In some examples, the computer system does not have a display generation component and does not present visual content to a user. In some examples, the computer system has a touch-sensitive display (also known as a “touch screen” or “touch-screen display”). In some examples, the computer system has one or more eye-tracking components. In some examples, the computer system has one or more hand-tracking components. In some examples, the computer system has one or more output devices, the output devices including one or more tactile output generators and/or one or more audio output devices. In some examples, the computer system has one or more processors, memory, and one or more modules, programs or sets of instructions stored in the memory for performing various functions described herein. In some examples, the user interacts with the computer system through a stylus and/or finger contacts and gestures on the touch-sensitive surface, movement of the user's eyes and hand in space or the user's body as captured by cameras and other movement sensors, and/or voice inputs as captured by one or more audio input devices. Executable instructions for performing these functions are, optionally, included in a transitory and/or non-transitory computer-readable storage medium or other computer program product configured for execution by one or more processors.

Note that the various examples described above can be combined with any other examples described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described examples, reference should be made to the Detailed Description below, in conjunction with the following drawings in which like reference numerals refer to corresponding parts throughout the figures.

FIG. 1 is a block diagram illustrating an operating environment of a computer system for interacting with three-dimensional (3D) scenes, according to some examples.

FIG. 2 is a block diagram of a user-facing component of the computer system, according to some examples.

FIG. 3 is a block diagram of a controller of the computer system, according to some examples.

FIG. 4 illustrates an architecture for a foundation model, according to some examples.

FIG. 5 illustrates a block diagram of a system for providing contextual translations, according to some examples.

FIGS. 6A-6D illustrate contextual translations provided by a digital assistant, according to some examples.

FIGS. 7A-7C illustrate flow diagrams of a method for providing contextual translations, according to some examples.

### DETAILED DESCRIPTION

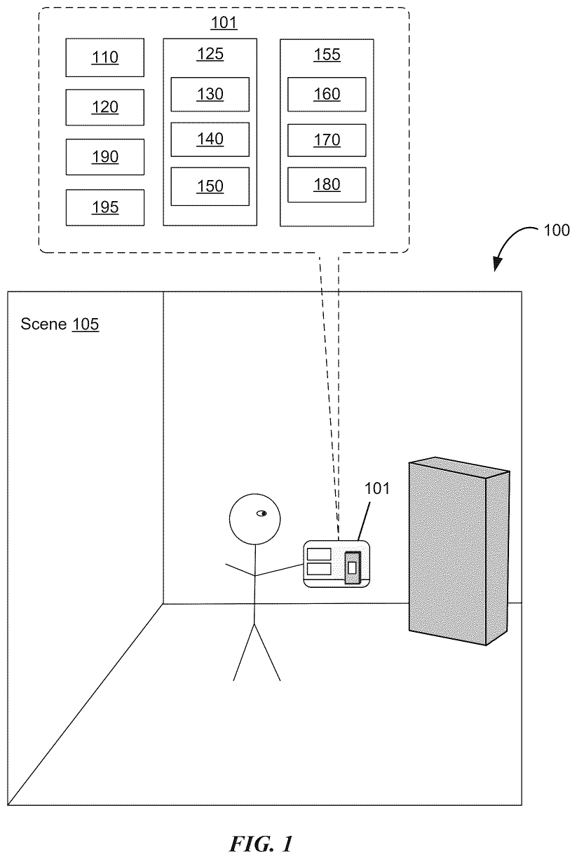

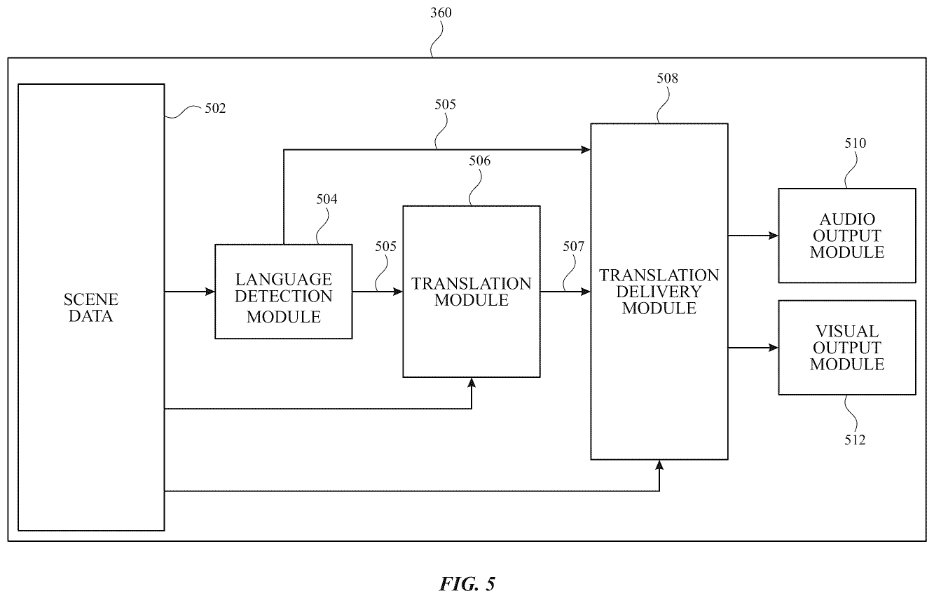

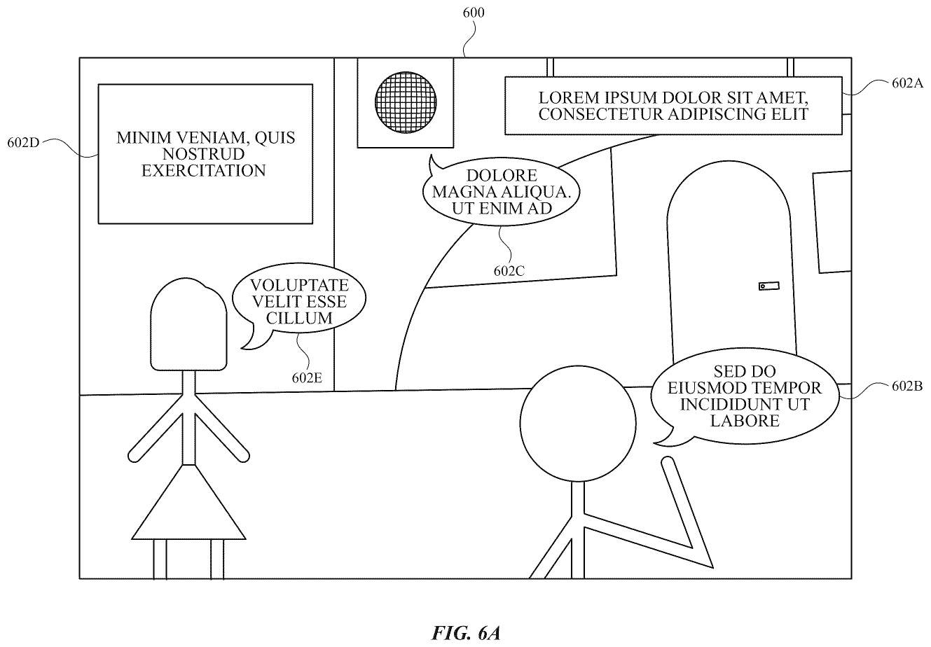

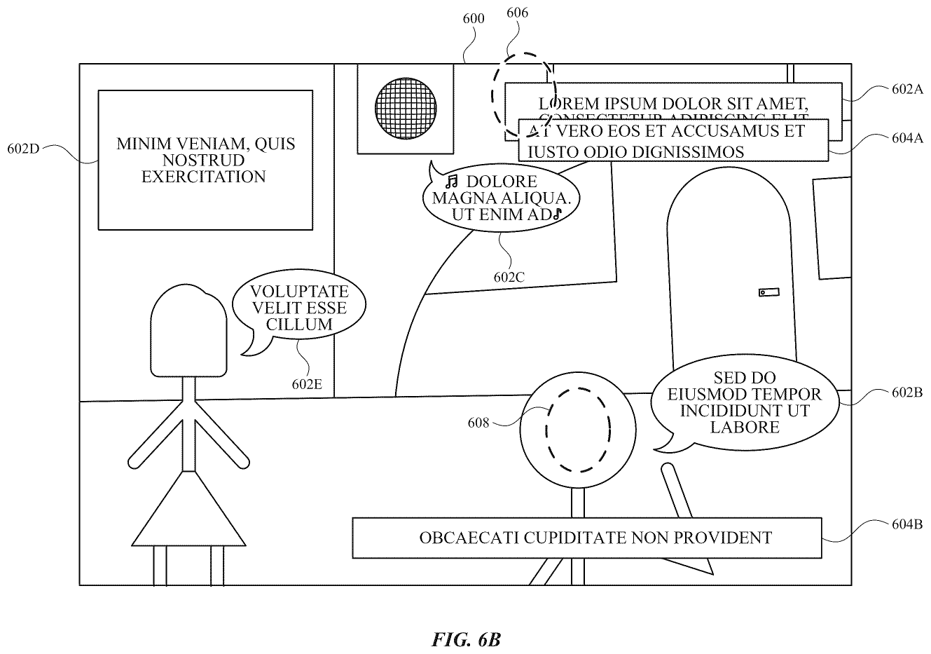

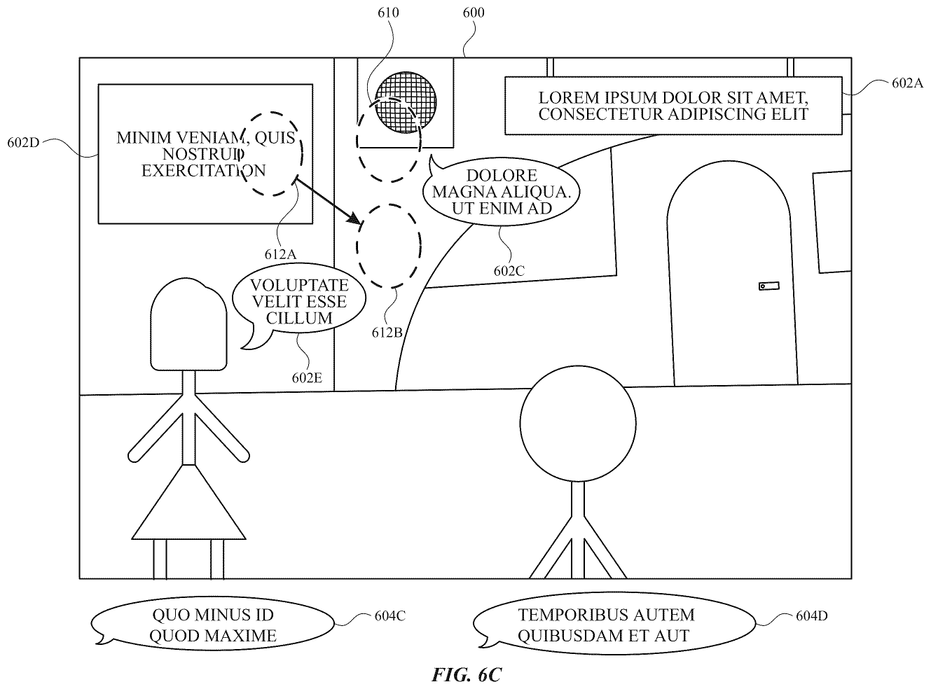

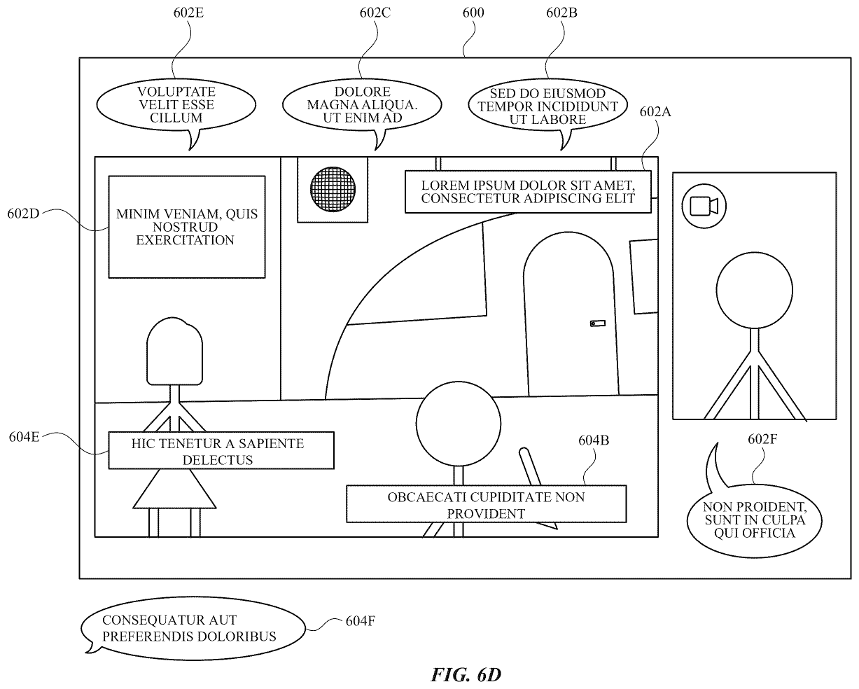

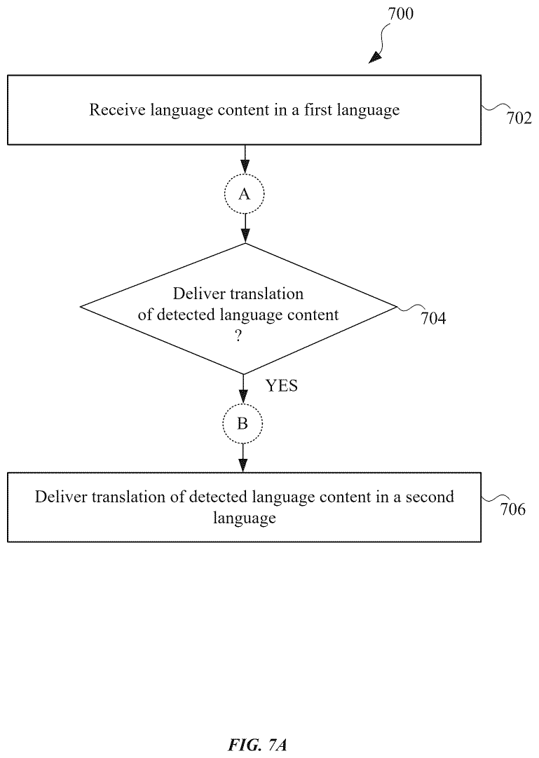

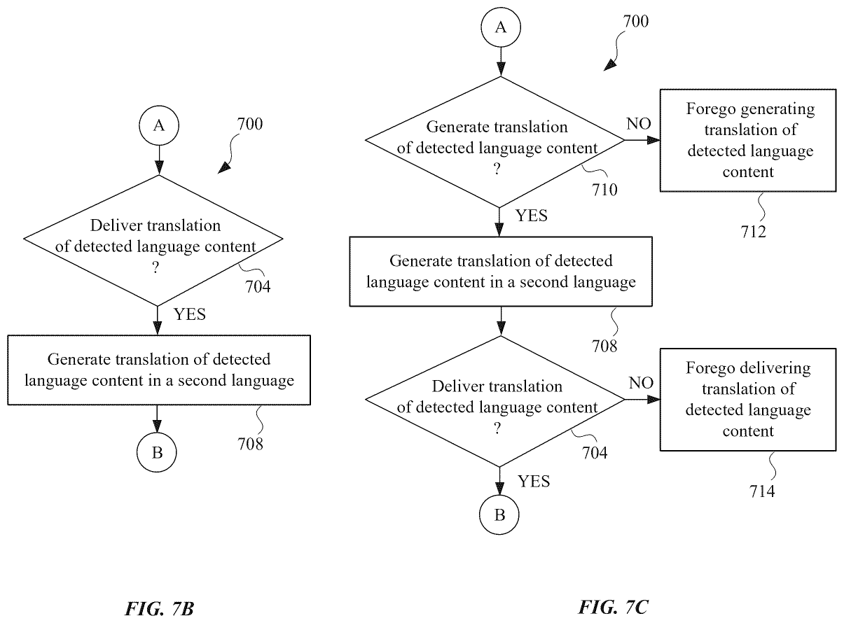

FIGS. 1-4 provide a description of example computer systems and techniques for interacting with three-dimensional scenes. FIGS. 5 and 6A-6D illustrate systems and processes for providing contextual translations. FIGS. 7A-7C illustrate flow diagrams of a method for providing contextual translations. FIGS. 5 and 6A-6D are used to describe the methods of FIGS. 7A-7C.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer-readable medium claims where the system or computer-readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer-readable storage medium can repeat the steps of a method as many times as are needed to ensure that all of the contingent steps have been performed.

FIG. 1 is a block diagram illustrating an operating environment of computer system 101 for interacting with three-dimensional scenes, according to some examples. In FIG. 1, a user interacts with three-dimensional scene 105 via operating environment 100 that includes computer system 101. In some examples, computer system 101 includes controller 110 (e.g., processors of a portable electronic device or a remote server), user-facing component 120, one or more input devices 125 (e.g., eye tracking device 130, hand tracking device 140, and/or other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, audio sensors, etc.), and one or more peripheral devices 195 (e.g., home appliances, wearable devices, etc.). In some examples, one or more of input devices 125, output devices 155, sensors 190, and peripheral devices 195 are integrated with user-facing component 120 (e.g., in a head-mounted device or a handheld device).

While pertinent features of the operating environment 100 are shown in FIG. 1, those of ordinary skill in the art will appreciate from the present disclosure that various other features have not been illustrated for the sake of brevity and so as not to obscure more pertinent aspects of the examples disclosed herein.

Hardware: There are many different types of electronic systems that enable a person to sense and/or interact with three-dimensional scenes. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may include speakers and/or other audio output devices integrated into the head-mounted system for providing audio output. A head-mounted system may have one or more speaker(s) and an integrated opaque display. Alternatively, a head-mounted system may be configured to accept an external opaque display (e.g., a smartphone). Alternatively, a head-mounted system may be configured to operate without displaying content, e.g., so that the head-mounted system provides output to a user via tactile and/or auditory means. The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one example, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

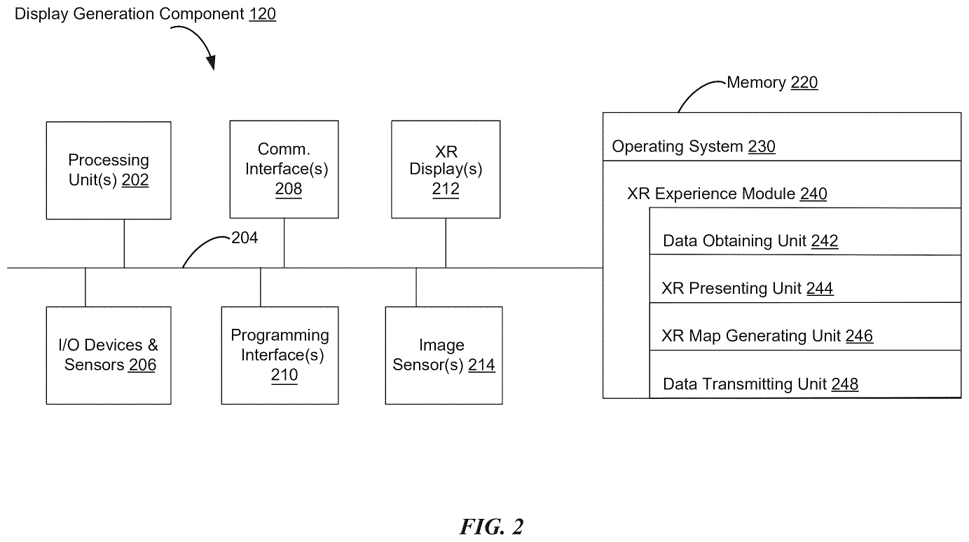

In some examples, user-facing component 120 is configured to provide a visual component of a three-dimensional scene. In some examples, user-facing component 120 includes a suitable combination of software, firmware, and/or hardware. User-facing component 120 is described in greater detail below with respect to FIG. 2. In some examples, the functionalities of controller 110 are provided by and/or combined with user-facing component 120. In some examples, user-facing component 120 provides an extended reality (XR) experience to the user while the user is virtually and/or physically present within scene 105.

In some examples, user-facing component 120 is worn on a part of the user's body (e.g., on his/her head, on his/her hand, etc.). In some examples, user-facing component 120 includes one or more XR displays provided to display the XR content. In some examples, user-facing component 120 encloses the field-of-view of the user. In some examples, user-facing component 120 is a handheld device (such as a smartphone or tablet) configured to present XR content, and the user holds the device with a display directed towards the field-of-view of the user and a camera directed towards the scene 105. In some examples, the handheld device is optionally placed within an enclosure that is worn on the head of the user. In some examples, the handheld device is optionally placed on a support (e.g., a tripod) in front of the user. In some examples, user-facing component 120 is an XR chamber, enclosure, or room configured to present XR content in which the user does not wear or hold user-facing component 120. Many user interfaces described with reference to one type of hardware for displaying XR content (e.g., a handheld device or a device on a tripod) could be implemented on another type of hardware for displaying XR content (e.g., a head-mounted device (HMD) or other wearable computing device). For example, a user interface showing interactions with XR content triggered based on interactions that happen in a space in front of a handheld or tripod-mounted device could similarly be implemented with an HMD where the interactions happen in a space in front of the HMD and the responses of the XR content are displayed via the HMD. Similarly, a user interface showing interactions with XR content triggered based on movement of a handheld or tripod-mounted device relative to the physical environment (e.g., scene 105 or a part of the user's body (e.g., the user's eye(s), head, or hand)) could similarly be implemented with an HMD where the movement is caused by movement of the HMD relative to the physical environment (e.g., scene 105 or a part of the user's body (e.g., the user's eye(s), head, or hand)).

FIG. 2 is a block diagram of user-facing component 120, according to some examples. While certain specific features are illustrated, those skilled in the art will appreciate from the present disclosure that various other features have not been illustrated for the sake of brevity, and so as not to obscure more pertinent aspects of the examples disclosed herein. Moreover, FIG. 2 is intended more as a functional description of the various features that could be present in a particular implementation, as opposed to a structural schematic of the examples described herein. As recognized by those of ordinary skill in the art, components shown separately could be combined and some components could be separated. For example, some functional modules shown separately in FIG. 2 could be implemented in a single module and the various functions of single functional blocks could be implemented by one or more functional blocks in various examples. The actual number of modules and the division of particular functions and how features are allocated among them will vary from one implementation to another and, in some examples, depends in part on the particular combination of hardware, software, and/or firmware chosen for a particular implementation.

In some examples, user-facing component 120 (e.g., HMD) includes one or more processing units 202 (e.g., microprocessors, ASICs, FPGAs, GPUs, CPUs, processing cores, and/or the like), one or more input/output (I/O) devices and sensors 206, one or more communication interfaces 208 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 210, one or more XR displays 212, one or more optional interior- and/or exterior-facing image sensors 214, a memory 220, and one or more communication buses 204 for interconnecting these and various other components.

In some examples, one or more communication buses 204 include circuitry that interconnects and controls communications between system components. In some examples, one or more I/O devices and sensors 206 include at least one of an inertial measurement unit (IMU), an accelerometer, a gyroscope, a thermometer, one or more biometric sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some examples, one or more XR displays 212 are configured to provide an XR experience to the user. In some examples, one or more XR displays 212 correspond to holographic, digital light processing (DLP), liquid-crystal display (LCD), liquid-crystal on silicon (LCoS), organic light-emitting field-effect transistor (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some examples, one or more XR displays 212 correspond to diffractive, reflective, polarized, holographic, etc. waveguide displays. For example, user-facing component 120 (e.g., HMD) includes a single XR display. In another example, user-facing component 120 includes an XR display for each eye of the user. In some examples, one or more XR displays 212 are capable of presenting XR content. In some examples, one or more XR displays 212 are omitted from user-facing component 120. For example, user-facing component 120 does not include any component that is configured to display content (or does not include any component that is configured to display XR content) and user-facing component 120 provides output via audio and/or haptic output types.

In some examples, one or more image sensors 214 are configured to obtain image data that corresponds to at least a portion of the face of the user that includes the eyes of the user (and may be referred to as an eye-tracking camera). In some examples, one or more image sensors 214 are configured to obtain image data that corresponds to at least a portion of the user's hand(s) and, optionally, arm(s) of the user (and may be referred to as a hand-tracking camera). In some examples, one or more image sensors 214 are configured to be forward-facing to obtain image data that corresponds to the scene as would be viewed by the user if user-facing component 120 (e.g., HMD) was not present (and may be referred to as a scene camera). One or more optional image sensors 214 can include one or more RGB cameras (e.g., with a complementary metal-oxide-semiconductor (CMOS) image sensor or a charge-coupled device (CCD) image sensor), one or more infrared (IR) cameras, one or more event-based cameras, and/or the like.

Memory 220 includes high-speed random-access memory, such as DRAM, SRAM, DDR RAM, or other random-access solid-state memory devices. In some examples, memory 220 includes non-volatile memory, such as one or more magnetic disk storage devices, optical disk storage devices, flash memory devices, or other non-volatile solid-state storage devices. Memory 220 optionally includes one or more storage devices remotely located from the one or more processing units 202. Memory 220 comprises a non-transitory computer-readable storage medium. In some examples, memory 220 or the non-transitory computer-readable storage medium of memory 220 stores the following programs, modules and data structures, or a subset thereof, including optional operating system 230 and XR experience module 240.

Operating system 230 includes instructions for handling various basic system services and for performing hardware dependent tasks. In some examples, XR experience module 240 is configured to present XR content to the user via one or more XR displays 212 or one or more speakers. To that end, in various examples, XR experience module 240 includes data obtaining unit 242, XR presenting unit 244, XR map generating unit 246, and data transmitting unit 248.

In some examples, data obtaining unit 242 is configured to obtain data (e.g., presentation data, interaction data, sensor data, location data, etc.) from at least controller 110 of FIG. 1. To that end, in various examples, data obtaining unit 242 includes instructions and/or logic therefor, and heuristics and metadata therefor.

In some examples, XR presenting unit 244 is configured to present XR content via one or more XR displays 212 or one or more speakers. To that end, in various examples, XR presenting unit 244 includes instructions and/or logic therefor, and heuristics and metadata therefor.

In some examples, XR map generating unit 246 is configured to generate an XR map (e.g., a 3D map of the extended reality scene or a map of the physical environment into which computer-generated objects can be placed) based on media content data. To that end, in various examples, XR map generating unit 246 includes instructions and/or logic therefor, and heuristics and metadata therefor.

In some examples, the data transmitting unit 248 is configured to transmit data (e.g., presentation data, location data, sensor data, etc.) to at least controller 110, and optionally one or more of input devices 125, output devices 155, sensors 190, and/or peripheral devices 195. To that end, in various examples, data transmitting unit 248 includes instructions and/or logic therefor, and heuristics and metadata therefor.

Although data obtaining unit 242, XR presenting unit 244, XR map generating unit 246, and data transmitting unit 248 are shown as residing on a single device (e.g., user-facing component 120 of FIG. 1), in other examples, any combination of data obtaining unit 242, XR presenting unit 244, XR map generating unit 246, and data transmitting unit 248 may reside on separate computing devices.

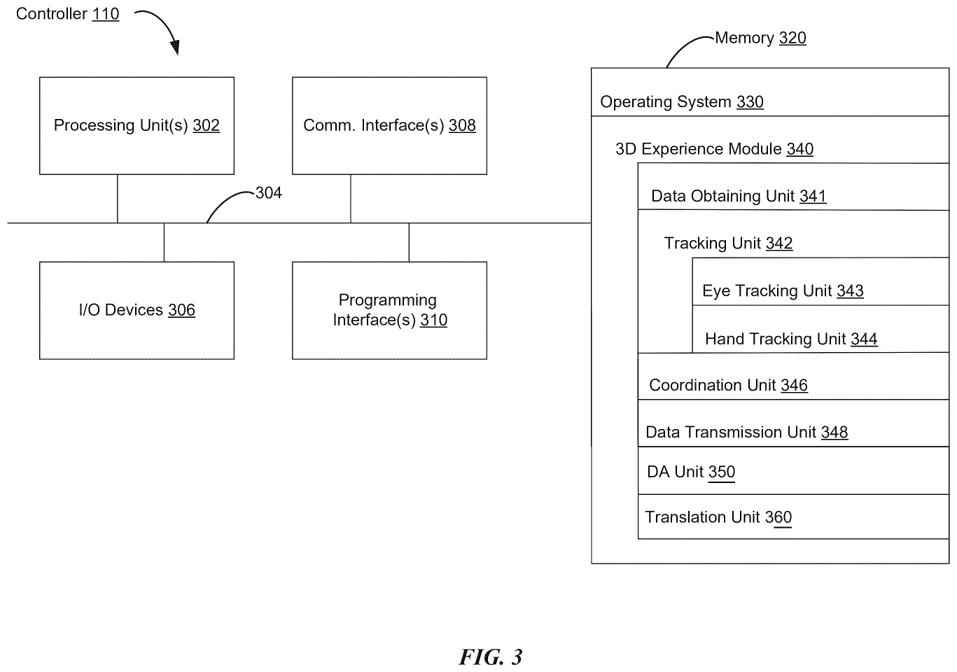

Returning to FIG. 1, controller 110 is configured to manage and coordinate a user's experience with respect to a three-dimensional scene. In some examples, controller 110 includes a suitable combination of software, firmware, and/or hardware. Controller 110 is described in greater detail below with respect to FIG. 3.

In some examples, controller 110 is a computing device that is local or remote relative to scene 105 (e.g., a physical environment). For example, controller 110 is a local server located within scene 105. In another example, controller 110 is a remote server located outside of scene 105 (e.g., a cloud server, central server, etc.). In some examples, controller 110 is communicatively coupled with the component(s) of computer system 101 that are configured to provide output to the user (e.g., output devices 155 and/or user-facing component 120) via one or more wired or wireless communication channels (e.g., BLUETOOTH, IEEE 802.11x, IEEE 802.16x, IEEE 802.3x, etc.). In some examples, controller 110 is included within the enclosure (e.g., a physical housing) of the component(s) of computer system 101 that are configured to provide output to the user (e.g., user-facing component 120) or shares the same physical enclosure or support structure with the component(s) of computer system 101 that are configured to provide output to the user.

In some examples, the various components and functions of controller 110 described below with respect to FIGS. 3, 4, 5, 6A-6D, and 7A-7C are distributed across multiple devices. For example, a first set of the components of controller 110 (and their associated functions) are implemented on a server system remote to scene 105 while a second set of the components of controller 110 (and their associated functions) are local to scene 105. For example, the second set of components are implemented within a portable electronic device (e.g., a wearable device such as an HMD) that is present within scene 105. It will be appreciated that the particular manner in which the various components and functions of controller 110 are distributed across various devices can vary based on different implementations of the examples described herein.

FIG. 3 is a block diagram of a controller 110, according to some examples. While certain specific features are illustrated, those skilled in the art will appreciate from the present disclosure that various other features have not been illustrated for the sake of brevity, and so as not to obscure more pertinent aspects of the examples disclosed herein. Moreover, FIG. 3 is intended more as a functional description of the various features that may be present in a particular implementation, as opposed to a structural schematic of the examples described herein. As recognized by those of ordinary skill in the art, components shown separately could be combined and some components could be separated. For example, some functional modules shown separately in FIG. 3 could be implemented in a single module and the various functions of single functional blocks could be implemented by one or more functional blocks in various examples. The actual number of modules and the division of particular functions and how features are allocated among them will vary from one implementation to another and, in some examples, depends in part on the particular combination of hardware, software, and/or firmware chosen for a particular implementation.

In some examples, controller 110 includes one or more processing units 302 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 306, one or more communication interfaces 308 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 310, memory 320, and one or more communication buses 304 for interconnecting these and various other components.

In some examples, one or more communication buses 304 include circuitry that interconnects and controls communications between system components. In some examples, one or more I/O devices 306 include at least one of a keyboard, a mouse, a touchpad, a joystick, one or more microphones, one or more speakers, one or more image sensors, one or more displays, and/or the like.

Memory 320 includes high-speed random-access memory, such as dynamic random-access memory (DRAM), static random-access memory (SRAM), double-data-rate random-access memory (DDR RAM), or other random-access solid-state memory devices. In some examples, memory 320 includes non-volatile memory, such as one or more magnetic disk storage devices, optical disk storage devices, flash memory devices, or other non-volatile solid-state storage devices. Memory 320 optionally includes one or more storage devices remotely located from the one or more processing units 302. Memory 320 comprises a non-transitory computer-readable storage medium. In some examples, memory 320 or the non-transitory computer-readable storage medium of memory 320 stores the following programs, modules and data structures, or a subset thereof, including an optional operating system 330 and three-dimensional (3D) experience module 340.

Operating system 330 includes instructions for handling various basic system services and for performing hardware-dependent tasks.

In some examples, three-dimensional (3D) experience module 340 is configured to manage and coordinate the user experience provided by computer system 101 with respect to a three-dimensional scene. For example, 3D experience module 340 is configured to obtain data corresponding to the three-dimensional scene (e.g., data generated by computer system 101 and/or data from data obtaining unit 341 discussed below) to cause computer system 101 to perform actions for the user (e.g., provide suggestions, display content, etc.) based on the data. To that end, in various examples, 3D experience module 340 includes data obtaining unit 341, tracking unit 342, coordination unit 346, data transmission unit 348, digital assistant (DA) unit 350, and translation unit 360.

In some examples, data obtaining unit 341 is configured to obtain data (e.g., presentation data, interaction data, sensor data, location data, etc.) from one or more of user-facing component 120, input devices 125, output devices 155, sensors 190, and peripheral devices 195. To that end, in various examples, data obtaining unit 341 includes instructions and/or logic therefor, and heuristics and metadata therefor.

In some examples, tracking unit 342 is configured to map scene 105 and to track the position/location of the user (and/or of a portable device being held or worn by the user). To that end, in various examples, tracking unit 342 includes instructions and/or logic therefor, and heuristics and metadata therefor.

In some examples, tracking unit 342 includes eye tracking unit 343. Eye tracking unit 343 includes instructions and/or logic for tracking the position and movement of the user's gaze (or more broadly, the user's eyes, face, or head) using data obtained from eye tracking device 130. In some examples, eye tracking unit 343 tracks the position and movement of the user's gaze relative to a physical environment, relative to the user (e.g., the user's hand, face, or head), relative to a device worn or held by the user, and/or relative to content displayed by user-facing component 120.

Eye tracking device 130 is controlled by eye tracking unit 343 and includes various hardware and/or software components configured to perform eye tracking techniques. For example, eye tracking device 130 includes at least one eye tracking camera (e.g., infrared (IR) or near-IR (NIR) cameras) and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards mirrors that reflect IR or NIR light from the eyes to the eye tracking cameras. Eye tracking device 130 optionally captures images of the user's eyes (e.g., as a video stream captured at 60-120 frames per second), analyzes the images to generate eye tracking information, and communicates the eye tracking information to eye tracking unit 343. In some examples, two eyes of the user are separately tracked by respective eye tracking cameras and illumination sources. In some examples, only one eye of the user is tracked by a respective eye tracking camera and illumination sources.

In some examples, tracking unit 342 includes hand tracking unit 344. Hand tracking unit 344 includes instructions and/or logic for tracking, using hand tracking data obtained from hand tracking device 140, the position of one or more portions of the user's hands and/or motions of one or more portions of the user's hands. Hand tracking unit 344 tracks the position and/or motion relative to scene 105, relative to the user (e.g., the user's head, face, or eyes), relative to a device worn or held by the user, relative to content displayed by user-facing component 120, and/or relative to a coordinate system defined relative to the user's hand. In some examples, hand tracking unit 344 analyzes the hand tracking data to identify a hand gesture (e.g., a pointing gesture, a pinching gesture, a clenching gesture, and/or a grabbing gesture) and/or to identify content (e.g., physical content or virtual content) corresponding to the hand gesture, e.g., content selected by the hand gesture. In some examples, a hand gesture is an air gesture. An air gesture is a gesture that is detected without the user touching (or independently of) an input element that is part of a device (e.g., computer system 101, one or more input devices 125, hand tracking device 140, and/or device 500) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

Hand tracking device 140 is controlled by hand tracking unit 344 and includes various hardware and/or software components configured to perform hand tracking and hand gesture recognition techniques. For example, hand tracking device 140 includes one or more image sensors (e.g., one or more IR cameras, 3D cameras, depth cameras, and/or color cameras, etc.) that capture three-dimensional information (e.g., a depth map) that represents a hand of a human user. The one or more image sensors capture the hand images with sufficient resolution to distinguish the fingers and their respective positions. In some examples, the one or more image sensors project a pattern of spots onto an environment that includes the hand and capture an image of the projected pattern. In some examples, the one or more image sensors capture a temporal sequence of the hand tracking data (e.g., captured three-dimensional information and/or captured images of the projected pattern) and hand tracking device 140 communicates the temporal sequence of the hand tracking data to hand tracking unit 344 for further analysis, e.g., to identify hand gestures, hand poses, and/or hand movements.

In some examples, hand tracking device 140 includes one or more hardware input devices configured to be worn and/or held by (or be otherwise attached to) one or more respective hands of the user. In such examples, hand tracking unit 344 tracks the position, pose, and/or motion of a user's hand based on tracking the position, pose, and/or motion of the respective hardware input device. Hand tracking unit 344 tracks the position, pose, and/or motion of the respective hardware input device optically (e.g., via one or more image sensors) and/or based on data obtained from sensor(s) (e.g., accelerometer(s), magnetometer(s), gyroscope(s), inertial measurement unit(s), and the like) contained within the hardware input device. In some examples, the hardware input device includes one or more physical controls (e.g., button(s), touch-sensitive surface(s), pressure-sensitive surface(s), knob(s), joystick(s), and the like). In some examples, instead of, or in addition to, performing a particular function in response to detecting a respective type of hand gesture, computer system 101 analogously performs the particular function in response to a user input that selects a respective physical control of the hardware input device. For example, computer system 101 interprets a pinching hand gesture input as a selection of an in-focus element and/or interprets selection of a physical button of the hardware device as a selection of the in-focus element.

In some examples, coordination unit 346 is configured to manage and coordinate the experience provided to the user via user-facing component 120, one or more output devices 155, and/or one or more peripheral devices 195. To that end, in various examples, coordination unit 346 includes instructions and/or logic therefor, and heuristics and metadata therefor.

In some examples, data transmission unit 348 is configured to transmit data (e.g., presentation data, location data, etc.) to user-facing component 120, one or more input devices 125, output devices 155, sensors 190, and/or peripheral devices 195. To that end, in various examples, data transmission unit 348 includes instructions and/or logic therefor, and heuristics and metadata therefor.

Digital assistant (DA) unit 350 includes instructions and/or logic for providing DA functionality to computer system 101. DA unit 350 therefore provides a user of computer system 101 with DA functionality while they and/or their avatar are present in a three-dimensional scene. For example, the DA performs various tasks related to the three-dimensional scene based on a determined user intent, either proactively or upon request from the user.

Translation unit 360 is configured to translate foreign language content (e.g., language content in a language that a user of computer system 101 does not understand, is not fluent in, and/or does not prefer) into a user's preferred language and to provide the translated language content to the user. Translation unit 360 is discussed in greater detail below with respect to FIG. 5.

In some examples, 3D experience module 340 accesses one or more artificial intelligence (AI) models that are configured to perform various functions described herein. The AI model(s) are at least partially implemented on controller 110 (e.g., implemented locally on a single device, or implemented in a distributed manner) and/or controller 110 communicates with one or more external services that provide access to the AI model(s). In some examples, one or more components and functions of DA unit 350 and/or translation unit 360 are implemented using the AI model(s). For example, DA unit 350 implements one or more AI models to perform speech recognition, intent determination (e.g., natural language processing and/or image processing), and/or response generation, and translation unit 360 implements one or more AI models to generate translated language content from foreign language content.

In some examples, the AI model(s) are based on (e.g., are, or are constructed from) one or more foundation models. Generally, a foundation model is a deep learning neural network that is trained based on a large training dataset and that can adapt to perform a specific function. Accordingly, a foundation model aggregates information learned from a large (and optionally, multimodal) dataset and can adapt to (e.g., be fine-tuned to) perform various downstream tasks that the foundation model may not have been originally designed to perform. Examples of such tasks include language translation, speech recognition, user intent determination (e.g., natural language processing), sentiment analysis, computer vision tasks (e.g., object recognition and scene understanding), question answering, image generation, audio generation, and generation of computer-executable instructions. Foundation models can accept a single type of input (e.g., text data) or accept multimodal input, such as two or more of text data, image data, video data, audio data, sensor data, and the like. In some examples, a foundation model is prompted to perform a particular task by providing it with a natural language description of the task. Example foundation models include the GPT-n series of models (e.g., GPT-1, GPT-2, GPT-3, and GPT-4), DALL-E, and CLIP from Open AI, Inc., Florence and Florence-2 from Microsoft Corporation, BERT from Google LLC, and LLaMA, LLaMA-2, and LLaMA-3 from Meta Platforms, Inc.

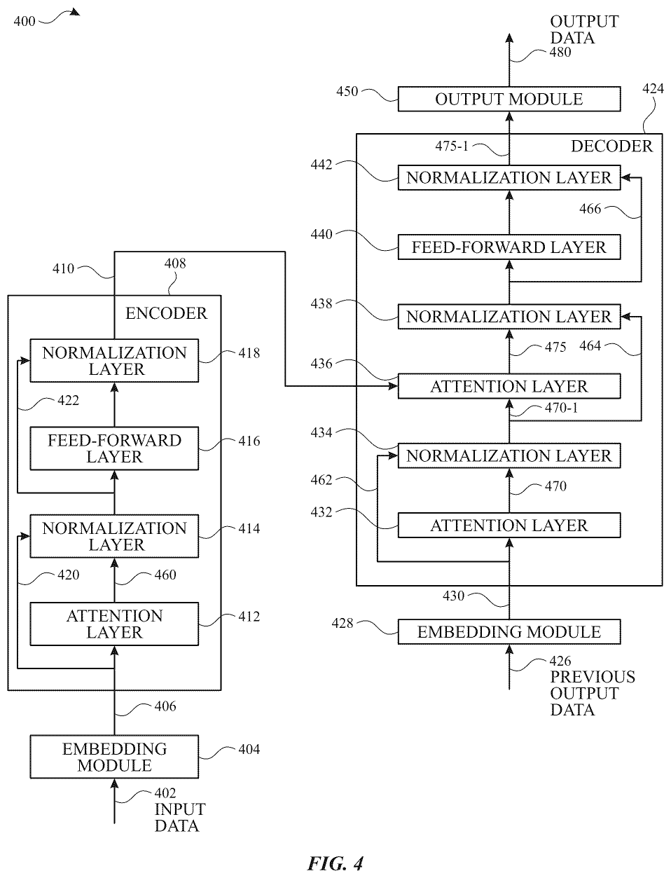

FIG. 4 illustrates architecture 400 for a foundation model, according to some examples. Architecture 400 is merely exemplary and various modifications to architecture 400 are possible. Accordingly, the components of architecture 400 (and their associated functions) can be combined, the order of the components (and their associated functions) can be changed, components of architecture 400 can be removed, and other components can be added to architecture 400. Further, while architecture 400 is transformer-based, one of skill in the art will understand that architecture 400 can additionally or alternatively implement other types of machine learning models, such as convolutional neural network (CNN)-based models and recurrent neural network (RNN)-based models.

Architecture 400 is configured to process input data 402 to generate output data 480 that corresponds to a desired task. Input data 402 includes one or more types of data, e.g., text data, image data, video data, audio data, sensor (e.g., motion sensor, biometric sensor, temperature sensor, and the like) data, computer-executable instructions, structured data (e.g., in the form of an XML file, a JSON file, or another file type), and the like. In some examples, input data 402 includes data from data obtaining unit 341. Output data 480 includes one or more types of data that depend on the task to be performed. For example, output data 480 includes one or more of: text data, image data, audio data, and computer-executable instructions. It will be appreciated that the above-described input and output data types are merely exemplary and that architecture 400 can be configured to accept various types of data as input and generate various types of data as output. Such data types can vary based on the particular function the foundation model is configured to perform.

Architecture 400 includes embedding module 404, encoder 408, embedding module 428, decoder 424, and output module 450, the functions of which are now discussed below.

Embedding module 404 is configured to accept input data 402 and parse input data 402 into one or more token sequences. Embedding module 404 is further configured to determine an embedding (e.g., a vector representation) of each token that represents each token in embedding space, e.g., so that similar tokens have a closer distance in embedding space and dissimilar tokens have a further distance. In some examples, embedding module 404 includes a positional encoder configured to encode positional information into the embeddings. The respective positional information for an embedding indicates the embedding's relative position in the sequence. Embedding module 404 is configured to output embedding data 406 of the input data by aggregating the embeddings for the tokens of input data 402.

Encoder 408 is configured to map embedding data 406 into encoder representation 410. Encoder representation 410 represents contextual information for each token that indicates learned information about how each token relates to (e.g., attends to) each other token. Encoder 408 includes attention layer 412, feed-forward layer 416, normalization layers 414 and 418, and residual connections 420 and 422. In some examples, attention layer 412 applies a self-attention mechanism on embedding data 406 to calculate an attention representation (e.g., in the form of a matrix) of the relationship of each token to each other token in the sequence. In some examples, attention layer 412 is multi-headed to calculate multiple different attention representations of the relationship of each token to each other token, where each different representation indicates a different learned property of the token sequence. Attention layer 412 is configured to aggregate the attention representations to output attention data 460 indicating the cross-relationships between the tokens from input data 402. In some examples, attention layer 412 further masks attention data 460 to suppress data representing the relationships between select tokens. Encoder 408 then passes (optionally masked) attention data 460 through normalization layer 414, feed-forward layer 416, and normalization layer 418 to generate encoder representation 410. Residual connections 420 and 422 can help stabilize and shorten the training and/or inference process by respectively allowing the output of embedding module 404 (i.e., embedding data 406) to directly pass to normalization layer 414 and allowing the output of normalization layer 414 to directly pass to normalization layer 418.

While FIG. 4 illustrates that architecture 400 includes a single encoder 408, in other examples, architecture 400 includes multiple stacked encoders configured to output encoder representation 410. Each of the stacked encoders can generate different attention data, which may allow architecture 400 to learn different types of cross-relationships between the tokens and generate output data 410 based on a more complete set of learned relationships.

Decoder 424 is configured to accept encoder representation 410 and previous output embedding 430 as input to generate output data 480. Embedding module 428 is configured to generate previous output embedding 430. Embedding module 428 is similar to embedding module 404. Specifically, embedding module 428 tokenizes previous output data 426 (e.g., output data 480 that was generated by the previous iteration), determines embeddings for each token, and optionally encodes positional information into each embedding to generate previous output embedding 430.

Decoder 424 includes attention layers 432 and 436, normalization layers 434, 438, and 442, feed-forward layer 440, and residual connections 462, 464, and 466. Attention layer 432 is configured to output attention data 470 indicating the cross-relationships between the tokens from previous output data 426. Attention layer 432 is similar to attention layer 412. For example, attention layer 432 applies a multi-headed self-attention mechanism on previous output embedding 430 and optionally masks attention data 470 to suppress data representing the relationships between select tokens (e.g., the relationship(s) between a token and future token(s)) so architecture 400 does not consider future tokens as context when generating output data 480. Decoder 424 then passes (optionally masked) attention data 470 through normalization layer 434 to generate normalized attention data 470-1.

Attention layer 436 accepts encoder representation 410 and normalized attention data 470-1 as input to generate encoder-decoder attention data 475. Encoder-decoder attention data 475 correlates input data 402 to previous output data 426 by representing the relationship between the output of encoder 408 and the previous output of decoder 424. Attention layer 436 allows decoder 424 to increase the weight of the portions of encoder representation 410 that are learned as more relevant to generating output data 480. In some examples, attention layer 436 applies a multi-headed attention mechanism to encoder representation 410 and to normalized attention data 470-1 to generate encoder-decoder attention data 475. In some examples, attention layer 436 further masks encoder-decoder attention data 475 to suppress the cross-relationships between select tokens.

Decoder 424 then passes (optionally masked) encoder-decoder attention data 475 through normalization layer 438, feed-forward layer 440, and normalization layer 442 to generate further-processed encoder-decoder attention data 475-1. Normalization layer 442 then provides further-processed encoder-decoder attention data 475-1 to output module 450. Similar to residual connections 420 and 422, residual connections 462, 464, and 466 may stabilize and shorten the training and/or inference process by allowing the output of a corresponding component to directly pass as input to a corresponding component.

While FIG. 4 illustrates that architecture 400 includes a single decoder 424, in other examples, architecture 400 includes multiple stacked decoders each configured to learn/generate different types of encoder-decoder attention data 475. This allows architecture 400 to learn different types of cross-relationships between the tokens from input data 402 and the tokens from output data 480, which may allow architecture 400 to generate output data 480 based on a more complete set of learned relationships.

Output module 450 is configured to generate output data 480 from further-processed encoder-decoder attention data 475-1. For example, output module 450 includes one or more linear layers that apply a learned linear transformation to further-processed encoder-decoder attention data 475-1 and a softmax layer that generates a probability distribution over the possible classes (e.g., words or symbols) of the output tokens based on the linear transformation data. Output module 450 then selects (e.g., predicts) an element of output data 480 based on the probability distribution. Architecture 400 then passes output data 480 as previous input data 426 to embedding module 428 to begin another iteration of the training and/or inference process for architecture 400.

It will be appreciated that various different AI models can be constructed based on the components of architecture 400. For example, some large language models (LLMs) (e.g., GPT-2 and GPT-3) are decoder-only (e.g., include one or more instances of decoder 424 and do not include encoder 408), some LLMs (e.g., BERT) are encoder-only (include one or more instances of encoder 408 and do not include decoder 424), and other foundation models (e.g., Florence-2) are encoder-decoder (e.g., include one or more instances of encoder 408 and include one or more instances of decoder 424). Further, it will be appreciated that the foundation models constructed based on the components of architecture 400 can be fine-tuned based on reinforcement learning techniques and training data specific to a particular task for optimization for the particular task, e.g., extracting relevant semantic information from image and/or video data, generating code, generating music, providing suggestions relevant to a specific user, and the like.

Returning to FIG. 3, translation unit 360 includes instructions and/or logic for detecting foreign language content, translating foreign language content, and providing translated language content to a user of computer system 101. Translation unit is described in detail below with respect to FIGS. 5, 6A-6D, and 7A-7C.

FIG. 5 illustrates a block diagram of translation unit 360, according to some examples. FIG. 5 is merely exemplary and various modifications to translation unit 360 are possible. Accordingly, the components of translation unit 360 (and their associated functions) can be combined, the order of the components (and their associated functions) can be changed, components of translation unit 360 can be removed, and other components can be added to translation unit 360.

As illustrated in FIG. 5, translation unit 360 includes language detection module 504. Language detection module 504 is configured to detect language content from scene data 502. Scene data 502 includes information detected and/or generated with respect to the current 3D scene (e.g., the physical or extended reality environment) and/or a current state of computer system 101. In some examples, scene data 502 includes data obtained by data obtaining unit 341. For example, scene data 502 includes image (e.g., photo and/or video) data of the scene, such as camera data captured from the scene using one or more cameras (e.g., physical and/or virtual cameras). As another example, scene data 502 includes audio data, such as audio detected in the scene using one or more audio input devices (e.g., microphones and/or bone vibration sensors). In some examples, scene data 502 includes other types of detected data, such as location data, motion data, hand tracking data, eye tracking (e.g., gaze) data, and/or other sensor data. In some examples, scene data 502 includes information about a current state of computer system 101, such as user preferences (e.g., user-customized settings for computer system 101), user information (e.g., calendar information, contact information, account information, and so forth), interaction history, application information, and/or device information. For example, scene data 502 includes information from or about media being played by computer system 101 and/or an ongoing communication session using computer system 101 (e.g., a phone call, video call, and/or text messaging conversation).

In some examples, computer system 101 obtains at least a portion of scene data 502 for a particular scene while the user (and/or at least a portion of computer system 101) are present within the particular scene. In some examples, computer system 101 generates at least a portion of scene data 502 for a virtual reality scene, such as a virtual reality scene being viewed by the user and/or within which an avatar of the user is present.

Language detection module 504 includes instructions, logic, and/or models (e.g., AI models) for extracting language content (e.g., foreign language content 505) from scene data 502 and identifying the language of the extracted language content. In particular, language detection module 504 is configured to extract language content from image data and audio data representing the current 3D scene, such as camera and microphone data captured from the physical environment. For example, language detection module 504 processes image data from scene data 502 using optical character recognition (OCR), edge detection, algorithmic image processing, and/or machine vision techniques (e.g., implementing a neural network, transformer, and/or other AI model) to extract a textual and/or tokenized representation of visible language content, such as typeset, handwritten, and/or stylized words, sub-word fragments, and characters seen in the 3D scene on signs, printed materials, displays, clothing, vehicles, buildings, and so forth. As another example, language detection module 504 processes audio data from scene data 502 using cross-correlation, speech-to-text (STT), natural language understanding (NLU) techniques (e.g., implementing a neural network, transformer, and/or other AI model) to extract a textual and/or tokenized representation of audible language content, such as vocalized, amplified, and/or synthesized speech detected from people, speakers, headphones, televisions, radios, phones, walkie-talkies, public announcement systems, and so forth.

Language detection module 504 is further configured to determine the language of extracted language content (e.g., identifying the most likely languages and/or dialects used in the language content). In some examples, the language is determined (e.g., using algorithmic and/or AI models) based on the textual and/or tokenized representation, the image and/or audio data from which the representation was extracted, and/or other data included in scene data 502. For example, based on extracted text, calendar data indicating that the user is at an event at the Mexican Cultural Institute, a Mexican flag detected in captured image data, and/or an accent detected in captured audio data, language detection module 504 identifies the extracted text as Spanish language text (e.g., and/or more particularly as Mexican Spanish).

As illustrated in FIG. 5, translation unit 360 includes translation module 506, which is configured to obtain translated language content 507, a translation of the foreign language content 505 extracted and identified by language detection module 504. Translation module 506 includes instructions, logic, and/or models (e.g., AI models) for translating language content from one language to another (e.g., generating, from a textual and/or tokenized representation of language content in one language, a textual and/or tokenized representation of the detected language content in a different language). For example, translation module 506 processes the textual and/or tokenized representation of the foreign language content using a semantic translation model, a large language model (e.g., LLM), and/or another machine translation model (e.g., implementing a neural network, transformer, and/or other AI model for generating translations of language).

In particular, translation module 506 is configured to generate translated language content 507 in the user's preferred language(s) from extracted foreign language content 505 (e.g., language content in a language that the user does not understand, is not fluent in, and/or does not prefer). For example, translation unit 360 can determine the user's preferred language(s) based on explicit user settings (e.g., user settings designating one or more default languages for computer system 101) and/or user preferences inferred from context information such as previous translation requests, past user inputs (e.g., typed, written, and/or spoken user inputs) in the language(s), keyboard (or operating system) settings corresponding to the language(s), and/or a user tendency to read, watch, listen to, and/or caption media in the language(s). Accordingly, if language detection module 504 extracts language content (e.g., foreign language content 505) in a language other than the user's preferred language(s), translation module 506 a translation of the language content in one (or more) of the user's preferred language(s).

In some examples, translation module 506 generates translated language content 507 from extracted foreign language content 505 when certain context criteria for translation are satisfied. For example, as described in further detail with respect to FIGS. 6A-6D, the context criteria for translation are satisfied when scene data 502 indicates that a translation of particular extracted foreign language content is likely to be relevant to, useful to, and/or desired by the user. For example, translation module 506 generates translated language content 507 if the scene data indicates that the user is in the audience of an opera performance and that the detected foreign language content is a song being sung in the opera (e.g., inferring that the user may be interested in a translation of the performance), but does not generate translated language content if the scene data indicates that the user is eating dinner with friends in a restaurant where the song is being played over the speakers. In some examples, translation module 506 generates translated language content 507 from extracted foreign language content 505 in response to receiving an instruction to generate the translated language content from translation delivery module 508, as described in further detail below.

In some examples, rather than generate translated language content 507 from foreign language content 505, translation module 506 may obtain translated language content 507 corresponding to foreign language content 505 from another source. For example, translation module 506 may retrieve captioning information for foreign language content in a broadcast or media item from metadata for the broadcast/media item. As another example, translation module 506 may perform a web search to obtain an official translation of foreign language content in a book or song.

As illustrated in FIG. 5, translation unit 360 includes translation delivery module 508, which is configured to output translation output 509 to the user via audio output module 510 (e.g., using one or more speakers, headphones, and/or other audio output devices) and/or visual output module 512 (e.g., using one or more display generation components, such as XR displays 212). Translation delivery module 508 includes instructions, logic, and/or models (e.g., AI models) for determining whether to output translation output 509 to the user via one or both of audio output module 510 and visual output module 512. For example, audio output module 510 is configured to output translation output 509 using synthesized speech, and visual output module 512 is configured to output translation output 509 using displayed text, symbols, graphics, and/or user interface elements. In some examples, translation output 509 includes translated language content 507 verbatim (e.g., synthesizing speech or displaying text to convey the translation itself) and/or content generated based on translated language content 507 (e.g., paraphrasing the translation, annotating the translation, and/or providing follow-up or related information with the translation).

In particular, as described in further detail with respect to FIGS. 6A-6D, based on one or more of scene data 502 (e.g., image data, audio data, and/or other context information), extracted foreign language content 505 (e.g., the language content extracted and identified by language detection module 504), and/or translated language content 507 (e.g., the translation generated by translation module 506), translation delivery module 508 determines whether and how to provide translation output 509 to the user.

In some examples, translation delivery module 508 determines to provide translation output 509 based at least in part on translated language content 507. Accordingly, in some examples, translation module 506 generates translated language content 507 prior to translation delivery module 508 determining to provide a translation of foreign language content 505. For example, translation delivery module 508 processes translated language content 507 using semantic analysis and/or natural-language understanding techniques to determine whether translated language content 507 should be provided to the user.

In some examples, translation delivery module 508 determines to provide translation output 509 to the user based only on scene data 502 (e.g., based on non-language context) and/or extracted foreign language content 505 (e.g., by performing semantic analysis and/or natural-language understanding in the native language of foreign language content 505) and not based on translated language content 507. Accordingly, in some examples, translation delivery module 508 determines to provide translation output 509 to the user prior to and/or in parallel with translation module 506 generating translated language content 507. In some examples, translation module 506 generates translated language content 507 specifically in response to translation delivery module 508 determining that translation output 509 should be provided to the user (e.g., translation delivery module 508 determines that extracted foreign language content 505 should be translated for the user and instructs translation module 506 to generate the translation to be output). For example, if scene data 502 indicates that the user is at an airport and extracted foreign language content 505 includes the user's name, the name of the user's destination city, the user's flight number, and/or an important safety announcement, translation delivery module 508 instructs translation module 506 to generate translated language content 507 (e.g., if translation module 506 has not done so already).

In some examples, translation delivery module 508 determines to output translation output 509 to the user when certain context criteria for translation delivery are satisfied. For example, as described in further detail with respect to FIGS. 6A-6D, the context criteria for translation delivery are satisfied when scene data 502 indicates that a translation of particular extracted foreign language content is likely to be relevant to, useful to, and/or desired by the user. For example, translation delivery module 508 determines to output translation output 509 if scene data 502 indicates that the user is currently attending a sporting event referenced in extracted foreign language content 505 and/or translated language content 507, but determines not to output translation output 509 if scene data 502 indicates that the user is engaged in an activity unrelated to the referenced sporting event.

In some examples, as described in further detail with respect to FIGS. 6A-6D, translation delivery module 508 determines to output translation output 509 via audio output module 510, visual output module 512, or both based on scene data 502, extracted foreign language content 505, and/or translated language content 507. For example, translation delivery module 508 determines to output translation output 509 via audio output module 510 (e.g., and not visual output module 512) based on scene data 502 indicating that the user is driving (e.g., indicating that the user should not be visually distracted), determines to output translation output 509 via visual output module 512 (e.g., and not audio output module 510) based on scene data 502 indicating that the user is in a library (e.g., indicating that the user may prefer silent outputs), and/or determines to output translation output 509 via both audio output module 510 and visual output module 512 based on translated language content 507 exceeding four sentences in length (e.g., indicating that the user may wish to read ahead and/or refer back to the textual translation while listening to the audio translation).

The above-described components of translation unit 360, including language detection module 504, translation module 506, and translation delivery module 508 are merely exemplary, and other architectures of translation unit 360 are possible. For example, translation unit 360 can implement various other types of AI-based techniques (e.g., based on the architecture described above with respect to FIG. 4) to process scene data 502, extracted foreign language content 505, and/or translated language content 507 to generate translation output 509.

FIGS. 6A-6D illustrate device 600 providing contextual translations, according to some examples. For illustrative purposes, both untranslated and translated language content is depicted in FIGS. 6A-6D using filler text, and it is to be understood that the language content can be translated to or from languages other than the specific languages described below, including other world languages, dialects, fictional languages, and/or code languages that device 600 (e.g., translation unit 360) is configured to detect, identify, translate, and/or output.

FIGS. 6A-6D illustrate a user's view of respective 3D scenes. In some examples, device 600 provides at least a portion of the scenes of FIGS. 6A-6D to the user, for instance, via one or more XR displays 212 or one or more speakers of user-facing component 120. For example, the scenes are XR scenes that include at least some virtual elements generated by device 600. In other examples, the scenes are physical scenes detected by device 500 (e.g., using one or more sensors) and/or provided to the user by device 500 (e.g., as pass-through video and/or audio).

Device 600 implements at least some of the components of computer system 101. For example, device 600 includes one or more sensors configured to detect data (e.g., image data and/or audio data) corresponding to the respective scenes. In some examples, device 600 is an HMD (e.g., an XR headset or smart glasses) and FIGS. 6A-6D illustrate the user's view of the respective scenes via the HMD. For example, FIGS. 6A-6D illustrate physical scenes viewed via pass-through video, physical scenes viewed via direct optical see-through, or virtual scenes viewed via one or more displays of the HMD. In other examples, device 600 is another type of device, such as a smart watch, a smart phone, a tablet device, a laptop computer, or a projection-based device.

The examples of FIGS. 6A-6D illustrate that the user and device 600 are present within the respective scenes. For example, the scenes are physical or extended reality scenes and the user and device 600 are physically present within the scenes. In other examples, an avatar of the user is present within the scenes. For example, when the scenes are virtual reality scenes, the avatar of the user is present within the virtual reality scenes.

FIG. 6A illustrates a scene at a train station that includes various items of language content 602A-602E (e.g., foreign language content) detected by device 600 (e.g., using language detection module 504). For example, language content 602A is text on a digital display for the train platform listing schedule and status information for arriving and departing trains; language content 602B is speech from a person standing directly in front of the user, language content 602C is audio emitted by a public announcement (PA) speaker in the train station, such as audible train announcements, weather reports, advertisements, and music; language content 602D is text on a printed sign hanging on the platform wall, and language content 602E is speech from a person standing farther away from the user. FIGS. 6B-6C illustrate various examples of providing translations of language content 602A-602E to the user via device 600.

In some examples, as described with respect to FIG. 5, device 600 extracts textual and/or tokenized representations of language content 602A-602E and identifies the language(s) of each item. For example, based on the extracted representations of language content 602A-602E and/or other content, such as location data indicating that the user is at the Shinjuku subway station in Tokyo, Japan; user data indicating that the user is scheduled to take an upcoming train from Shinjuku to Kyoto; and/or device data indicating that device 600 is connected to cellular service in Japan, device 600 identifies language content 602A-602E as written and spoken Japanese language content. As described with respect to FIG. 5, device 600 determines that Japanese is not one of the user's preferred languages. For example, because the default language for device 600 is set to American English, the user has requested machine translations of Japanese language content from device 600 in the past, and/or the user has a low proficiency score in Japanese in a language-learning application, device 600 identifies language content 602A-602E as foreign language content. Accordingly, device 600 determines whether to translate and deliver translations of language content 602A-602E to the user as described below with respect to the examples provided in FIGS. 6B-6D.

At FIG. 6B, device 600 determines that a translation of language content 602A should be delivered to the user (e.g., using translation delivery module 508). As described with respect to FIG. 5, in some examples, device 600 determines that a translation of language content 602A should be delivered to the user prior to translating language content 602A. For example, because the user is scheduled to take an upcoming train and the source of language content 602A is the digital display for the train platform, device 600 determines that a translation of language content 602A is likely to be relevant to the user as the user navigates the train station. As another example, device 600 detects (e.g., using eye tracking device 130) gaze input 606 directed to language content 602A, and thus infers a user intent to obtain a translation of language content 602A. As another example, device 600 analyzes the extracted Japanese text of language content 602A to determine that language content 602A includes train status information. Accordingly, in some examples, device 600 generates an English translation of language content 602A (e.g., using translation module 506) in response to determining that translation output 604A (e.g., described in detail below) should be provided to the user.

At FIG. 6B, device 600 additionally determines that a translation of language content 602B should be delivered to the user. As described with respect to FIG. 5, in some examples, device 600 determines that a translation of language content 602B should be delivered based at least in part on a translation of language content 602B (e.g., device 600 generates an English translation of language content 602B prior to determining that a translation should be delivered to the user). For example, device 600 translates language content 602B because the person speaking language content 602B is facing the user, because the person speaking language content 602B is recognized as a friend of the user (e.g., based on contact information, photos in the user's media library, and/or device connectivity), and/or gaze input 608 directed to the person speaking. The English translation of language content 602B can then be analyzed (e.g., using semantic analysis and/or natural-language understanding) to determine that language content 602B is directed to the user and therefore that a translation should be provided.

Device 600 thus provides English translations of language content 602A and language content 602B (e.g., obtained from translation module 506) to the user as translation output 604A and translation output 604B, respectively. As illustrated in FIG. 6B, translation output 604A provides a textual translation of language content 602A displayed (e.g., via visual output module 512) as a virtual object overlaying and/or near (e.g., visually near) language content 602A within the 3D scene. For example, device 600 provides the translation as a visual output because language content 602A was detected visually (e.g., providing a translation in the same mode that the foreign language content was detected), because gaze input 606 is directed to the location of language content 602A (e.g., indicating a user intent to read the display information), and/or because the information included language content 602A is suitable for a textual output (e.g., train status information can be quickly and clearly conveyed via a display).

As illustrated in FIG. 6B, translation output 604B provides a textual translation of language content 602B displayed (e.g., via visual output module 512) as a virtual object near the bottom of the user's field-of-view of the 3D scene and/or near the speaker of language content 602B, for example, as visual captioning for the audio of the conversation. For example, device 600 provides the translation as a visual output because language content 602B is detected in an in-person conversation (e.g., allowing the user to hear the audio of the conversation while reading the translation) and/or because device 600 determines that the train station is a loud setting (e.g., the user may not be able to hear an audible translation over the noise).

As illustrated in FIG. 6B, device 600 does not provide the user with translations of language content 602C, 602D, and 602E. As described with respect to FIG. 5, in some examples, device 600 generates translations of language content 602C, 602D, and/or 602E but determines not to deliver them to the user. For example, device 600 translates language content 602C because the PA system (e.g., the source of language content 602C) is likely to provide relevant information for the context of the train station, but determines based on the translation of language content 602C that language content 602C is an advertising jingle, and thus, does not need to be delivered to the user. As another example, device 600 translates language content 602D, but determines not to deliver the translation because the user is not currently looking at the sign. Alternatively, in some examples, device 600 determines not to generate translations of language content 602C, 602D, and 602E. For example, device 600 refrains from generating a translation of language content 602C because the audio of language content 602C is identified as a song (e.g., indicating that the PA system is not providing information relevant to the user's context), refrains from generating a translation of language content 602D because the user is not looking at the sign, and/or refrains from generating a translation of language content 602E because the person speaking is a stranger and is not looking at the user.

At FIG. 6C, device 600 determines that a translation of language content 602C should be delivered to the user (e.g., using translation delivery module 508). As described above, device 600 may generate an English translation of language content 602C either in response to determining that the translation should be delivered or preemptively (e.g., prior to determining that the translation should be delivered). For example, because the device 600 determines (e.g., based on the Japanese language content and/or a preemptively-generated English translation of the language content) that language content 602C includes an announcement about the train the user is scheduled to take, device 600 determines that language content 602C includes time-sensitive information that should be provided to the user. As another example, device 600 detects (e.g., using eye tracking device 130) gaze input 610 directed to the PA speaker, and thus infers a user intent to obtain a translation of language content 602C. As another example, device 600 determines to translate and/or deliver a translation of language content 602C based on other context information, such as detecting the user turning their head to listen to the PA speaker using motion sensors and/or determining that the user's train should be arriving soon based on ticketing information from the user's messages, email, and/or digital wallet.

As illustrated in FIG. 6C, device 600 provides translation output 604C, an audio output including a spoken translation of language content 602C (e.g., as speech synthesized from a textual and/or tokenized translation of language content 602C). For example, device 600 provides translation output 604C as an audio output to indicate the PA system speaker as the source of the translation (e.g., providing a translation in the same mode that the foreign language content was detected) and/or to draw the user's attention to the announcement (e.g., without the user needing to look at displayed content).

At FIG. 6C, device 600 generates an English translation of language content 602D, for instance, based on detecting gaze input 612A directed to the sign (e.g., and/or based on other contextual determinations such as those described above). However, as illustrated at FIG. 6C, after detecting the user looking at the sign, device 600 detects gaze input 612B moving away from the sign. Accordingly, device 600 provides the translation of language content 602D as translation output 604D, an audio output including a spoken translation of language content 602D. Alternatively, device 600 may refrain from providing the generated translation of language content 602D and/or cancel providing translation output 604D based on gaze input 612B (e.g., determining that the user does not wish to read the sign).

FIG. 6D illustrates a scene in which various items of language content are generated and/or provided by device 600. In particular, in FIG. 6D, language content 602A-602E are text and audio dialog included in a movie (e.g., or another video media item) being played by device 600 (e.g., and/or a device in communication with device 600, such as an external monitor or television) and language content 602F is audio received from a remote source (e.g., another user's device) as part of a live video communication session (e.g., video call) being presented by device 600 (e.g., and/or a device in communication with device 600). Accordingly, in some embodiments, at FIG. 6D, foreign language content 602A-602F is detected without using audio sensors or cameras.

As illustrated in FIG. 6D, in response to receiving language content 602F for the video communication session and determining that language content 602F is not in the user's preferred language(s), device 600 provides translation output 604F, an audio output including a spoken English translation of language content 602F. For example, because the user is participating in the live video communication session, device 600 determines a user intent to have language content 602F translated and thus provides live “dubbing” for the video call.

Additionally, at FIG. 6D, because language content 602B and language content 602E include dialog for the movie the user is watching, device 600 provides translation outputs 604B and 604E, displayed text captions including the English translations of language content 602B and language content 602E. For example, device 600 may generate English translations of language content 602B and 602E or may receive English translations of language content 602B and 602E, for instance, as metadata from the movie. In some examples, device 600 may receive and/or generate translations of language content 602A, 602C, and/or 602D, but, at FIG. 6D, device 600 determines that the translations should not be output. For example, device 600 determines that language content 602A, 602C, and/or 602D are relatively less important to the user's current context than language content 602F (e.g., the ongoing conversation), language content 602B, and language content 602E (e.g., the movie dialog), and thus refrains from providing translations unless the context changes (e.g., providing the translations if the user ends the video call or gazes at the text of 602A or 602E for over a threshold period of time).

Additional descriptions regarding FIGS. 6A-6D are provided below in reference to method 700 described below with respect to FIGS. 7A-7C.

FIGS. 7A-7C are a flow diagram of a method 700 for providing spoken responses using 3D audio effects, according to some examples. In some examples, method 700 is performed at a computer system (e.g., computer system 101 in FIG. 1 and/or device 600) that is in communication with one or more sensor devices (e.g., image sensors, light sensors, depth sensors, tactile sensors, orientation sensors, proximity sensors, temperature sensors, location sensors, motion sensors, velocity sensors, audio sensors, and/or biometric sensors). In some examples, method 700 is governed by instructions that are stored in a non-transitory (or transitory) computer-readable storage medium and that are executed by one or more processors of a computer system, such as the one or more processing unit(s) 302 of computer system 101 (e.g., controller 110 in FIG. 1). In some examples, the operations of method 700 are distributed across multiple computer systems, e.g., a computer system and a separate server system. Some operations in method 700 are, optionally, combined, the orders of some operations are, optionally, changed, and some operations are, optionally, omitted.

At block 702, language content (e.g., 602A, 602B, 602C, 602D, 602E, 602F, and/or extracted representations thereof (e.g., extracted foreign language content 505)) is received (e.g., via language detection module 504), wherein the language content is in a first language (e.g., identified via language detection module 504).

In some examples, receiving the language content includes detecting a first portion of the language content using the one or more sensor devices (e.g., as described with respect to FIGS. 6A-6C). For example, the language content is detected “live” in a physical environment. In some examples, receiving the language content includes obtaining data representing a second portion of the language content without using the one or more sensor devices (e.g., as described with respect to FIG. 6D). For example, the language content is included in data obtained directly by the computer system, such as media data, audio phone call data, video phone call data, and/or application data.

In some examples, the language content includes text content (e.g., 602A and/or 602D). In some examples, detecting the language content using the one or more sensor devices includes detecting the first portion of the language content using one or more cameras of the one or more sensor devices (e.g., as described with respect to 602A and/or 602D in FIG. 6A).

In some examples, the language content includes audio content (e.g., 602B, 602C, 602E, and/or 602F). In some examples, detecting the language content using the one or more sensor devices includes detecting the first portion of the language content using one or more audio sensor devices of the one or more sensor devices (e.g., as described with respect to 602B, 602C, and/or 602E in FIG. 6A).

At block 704, in response to receiving (A) the language content, a determination of whether a set of one or more translation delivery criteria is satisfied for the language content is made based on a first set of contextual information (e.g., scene data 502) and the language content (e.g., extracted foreign language content 505 and/or translated language content 507).

In some examples, determining (704) whether the set of one or more translation delivery criteria is satisfied for the language content includes determining, based on the first set of contextual information, a source of the language content, wherein the set of one or more translation delivery criteria includes a source criterion that is satisfied when the source of the language content is a respective type of source. For example, the respective type of source is a source that is likely to provide information that is relevant to, useful to, and/or desired by the user based on the first set of contextual information. For example, in the context described with respect to FIG. 6B, device 600 provides translation output 604C because the source of language content 602C is person the user knows (e.g., a contact of the user) who is talking directly to the user, but refrains from providing a translation of language content 602E because the source of language content 602E is a person the user does not know and who is facing away from the user. As another example, in the context described with respect to FIG. 6D, device 600 provides translation output 604F because the source of language content 602F is an ongoing video communication session with the user (e.g., language content 602F is received from a remote person the user is interacting with via the video communication session).

In some examples, determining (704) whether the set of one or more translation delivery criteria is satisfied for the language content includes determining, based on the first set of contextual information, whether user attention is directed to the language content, wherein the set of one or more translation delivery criteria includes an attention criterion that is satisfied when the user attention is directed to the language content (e.g., as described with respect to 606, 608, 610, and/or 612-1). For example, user attention is detected using gaze data (e.g., 606, 608, 610, 612-1, and/or 612-2), motion data (e.g., detecting the user moving their head to see or listen to the language content), audio data (e.g., detecting that audio is spatially directed to the user), image data (e.g., detecting that audio is from a person looking at the user), device information (e.g., determining that user has been interacting with the language content and/or the source of the content using the computer system, such as described with respect to FIG. 6D), and/or other types of scene data.

In some examples, determining (704) whether the set of one or more translation delivery criteria is satisfied for the language content includes determining whether the language content (e.g., extracted foreign language content 505 and/or translated language content 507) includes time-sensitive content, wherein the set of one or more translation delivery criteria includes a time-sensitivity criterion that is satisfied when the language content includes time-sensitive content. For example, as described with respect to FIG. 6C, computer system 600 provides translation output 604C based on a determination that language content 602C includes information related to the user's train, which is scheduled to depart soon.

In some examples, determining (704) whether the set of one or more translation delivery criteria is satisfied for the language content includes determining, based on the first set of contextual information, whether the language content (e.g., extracted foreign language content 505 and/or translated language content 507) includes contextually-relevant content, wherein the set of one or more translation delivery criteria includes a relevance criterion that is satisfied when the language content includes contextually-relevant content. For example, in the context described with respect to FIG. 6B, device 600 provides translation output 604A because language content 602A provides train status information relevant to the user's current context at the train station, but in the context described with respect to FIG. 6D, computer system 600 refrains from providing a translation of language content 602A because the status information provided by language content 602A is less relevant to the user's current context of watching a movie.

At block 706, in accordance with a determination (at 704) that the set of one or more translation delivery criteria is satisfied for the language content, a translation of the language content (e.g., 604A, 604B, 604C, 604D, 604E, and/or 604F) is delivered, wherein the translation is in a second language (e.g., at least one of the user's preferred languages) different from the first language. For example, in accordance with a determination (at 704) that the set of one or more translation delivery criteria is satisfied for the language content, the computer system obtains or generates (708) the translation of the language content (e.g., using translation module 506).

In some examples, delivering the translation of the language content includes outputting an audio representation of the translation (e.g., 604C, 604D, and/or 604F). In some examples, delivering the translation of the language content includes outputting a visual representation of the translation (e.g., 604A, 604B, and/or 604E).

In some examples, as illustrated in FIG. 7B, in accordance with a determination (704) that the set of one or more translation delivery criteria is satisfied for the language content (B), the language content is translated (708) into the second language to obtain the translation of the language content (e.g., using translation module 506). For example, as described with respect to FIG. 6B, device 600 determines that translation output 604B should be provided based on gaze input 608 and/or the visual context of the person speaking while looking at the user without first translating language content 602B, then generates the translation of language content 602B to provide in translation output 604B in accordance with that determination.

In some examples, as illustrated in FIG. 7C, in response to receiving the language content (A), the language content is translated (708) into a second language (e.g., the user's preferred language) to obtain a respective translation of the language content (e.g., translated language content 507), wherein determining (704) whether the set of one or more translation delivery criteria is satisfied for the language content is based on the respective translation of the language content (e.g., translated language content 507). For example, a translation of the received language content is generated prior to performing block 704 and the translated content is used (e.g., analyzed using semantic analysis and/or natural-language understanding) to determine whether or not to deliver (706) the generated translation. For example, device 600 may generate and analyze translations of language content 602A, 602B, 602C, 602D, 602E, and/or 602F in order to determine whether or not to output one or more of the corresponding translation outputs 604A, 604B, 604C, 604D, 604E, and/or 604F. In some examples, in accordance with a determination that the set of one or more translation delivery criteria is not satisfied based on the respective translation of the language content, at block 714, delivery of the translation of the language content is foregone.

In some examples, as illustrated in FIG. 7C, in response to receiving the language content (A), a determination (710) of whether a set of one or more context criteria is satisfied is made based on a second set of contextual information (e.g., scene data 502 and/or extracted foreign language content 505), and, at block 708, the language content is translated into the second language to obtain a respective translation of the language content (e.g., translated language content 507) in accordance with a determination that the set of one or more context criteria is satisfied. In some examples, in accordance with a determination that the set of one or more context criteria is not satisfied, at block 712, translation of the language to obtain the respective translation of the language content is foregone.

In some examples, the set of one or more translation delivery criteria includes at least one criterion not included in the set of one or more context criteria. For example, based on the current context, device 600 preemptively generates translations of language content 602A, 602B, 602C, 602D, 602E, and/or 602F but, based on the current context and/or the generated translation, refrains from outputting one or more of the corresponding translation outputs 604A, 604B, 604C, 604D, 604E, and/or 604F.

In some examples, the first set of contextual information (e.g., the context information used to determine whether to provide a translation) and the second set of contextual information (e.g., the context information used to determine whether to generate a translation) are different. For example, as described with respect to FIG. 6C, device 600 generates a translation of language content 602D based on context information (e.g., gaze input 612-1) indicating that the user is looking at the sign, but, based on context information (e.g., gaze input 612-2) indicating the user's gaze moving away from the sign, device 600 may refrain from providing translation output 604D. As another example, translation module 506 automatically generates translations of extracted language content based on context information indicating that the language content is not in one of the user's preferred languages, but translation delivery module 508 only outputs the translations if the user's attention is directed to the source of the extracted language content.

In some examples, as illustrated in FIG. 7C, determining (710) whether the set of one or more context criteria is satisfied is performed prior to determining (704) whether the set of one or more translation delivery criteria is satisfied.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to facilitate user interactions with a three-dimensional scene. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to output spoken responses to assist a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of outputting spoken responses for the user, the present technology can be configured to allow users to select to “opt in” or “opt out” of participation in the collection of personal information data during registration for services or anytime thereafter. In another example, users can select not to provide personal information data based on which on spoken responses are generated. In yet another example, users can select to limit the length of time for which such data is maintained. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, spoken responses can be generated based on non-personal information data or a bare minimum amount of personal information, such as the content being requested by the device associated with a user, other non-personal information available to the service, or publicly available information.

What is claimed is:

1. A computer system configured to communicate with one or more sensor devices, the computer system comprising:
one or more processors; and
memory storing one or more programs configured to be executed by the one or more processors, the one or more programs including instructions for:
receiving language content, wherein the language content is in a first language;
in response to receiving the language content, determining, based on a first set of contextual information and the language content, whether a set of one or more translation delivery criteria is satisfied for the language content; and,
in accordance with a determination that the set of one or more translation delivery criteria is satisfied for the language content, delivering a translation of the language content, wherein the translation is in a second language different from the first language.

2. The computer system of claim 1, wherein receiving the language content includes detecting a first portion of the language content using the one or more sensor devices.

3. The computer system of claim 2, wherein detecting the language content using the one or more sensor devices includes detecting the first portion of the language content using one or more cameras of the one or more sensor devices.

4. The computer system of claim 2, wherein detecting the language content using the one or more sensor devices includes detecting the first portion of the language content using one or more audio sensor devices of the one or more sensor devices.

5. The computer system of claim 1, wherein the language content includes audio content.

6. The computer system of claim 1, wherein the language content includes text content.

7. The computer system of claim 1, wherein delivering the translation of the language content includes outputting an audio representation of the translation.

8. The computer system of claim 1, wherein delivering the translation of the language content includes outputting a visual representation of the translation.

9. The computer system of claim 1, the one or more programs including instructions for:
in accordance with a determination that the set of one or more translation delivery criteria is satisfied for the language content, translating the language content into the second language to obtain the translation of the language content.

10. The computer system of claim 1, the one or more programs including instructions for:
in response to receiving the language content, translating the language content into the second language to obtain a respective translation of the language content, wherein determining whether the set of one or more translation delivery criteria is satisfied for the language content is further based on the respective translation of the language content.

11. The computer system of claim 1, the one or more programs including instructions for:
in response to receiving the language content, determining, based on a second set of contextual information, whether a set of one or more context criteria is satisfied; and
in accordance with a determination that the set of one or more context criteria is satisfied, translating the language content into the second language to obtain a respective translation of the language content.

12. The computer system of claim 11, wherein the set of one or more translation delivery criteria includes at least one criterion not included in the set of one or more context criteria.

13. The computer system of claim 11, wherein the first set of contextual information and the second set of contextual information are different.

14. The computer system of claim 11, wherein determining whether the set of one or more context criteria is satisfied is performed prior to determining whether the set of one or more translation delivery criteria is satisfied.

15. The computer system of claim 1, wherein determining whether the set of one or more translation delivery criteria is satisfied for the language content includes:
determining, based on the first set of contextual information, a source of the language content, wherein the set of one or more translation delivery criteria includes a source criterion that is satisfied when the source of the language content is a respective type of source.

16. The computer system of claim 1, wherein determining whether the set of one or more translation delivery criteria is satisfied for the language content includes:
determining, based on the first set of contextual information, whether user attention is directed to the language content, wherein the set of one or more translation delivery criteria includes an attention criterion that is satisfied when the user attention is directed to the language content.

17. The computer system of claim 1, wherein determining whether the set of one or more translation delivery criteria is satisfied for the language content includes:
determining whether the language content includes time-sensitive content, wherein the set of one or more translation delivery criteria includes a time-sensitivity criterion that is satisfied when the language content includes time-sensitive content.

18. The computer system of claim 1, wherein determining whether the set of one or more translation delivery criteria is satisfied for the language content includes:
determining, based on the first set of contextual information, whether the language content includes contextually-relevant content, wherein the set of one or more translation delivery criteria includes a relevance criterion that is satisfied when the language content includes contextually-relevant content.

19. A non-transitory computer-readable storage medium storing one or more programs configured to be executed by one or more processors of a computer system that is in communication with one or more sensor devices, the one or more programs including instructions for:
receiving language content, wherein the language content is in a first language;
in response to receiving the language content, determining, based on a first set of contextual information and the language content, whether a set of one or more translation delivery criteria is satisfied for the language content; and,
in accordance with a determination that the set of one or more translation delivery criteria is satisfied for the language content, delivering a translation of the language content, wherein the translation is in a second language different from the first language.

20. A method, comprising:
at a computer system that is in communication with one or more sensor devices:
receiving language content, wherein the language content is in a first language;
in response to receiving the language content, determining, based on a first set of contextual information and the language content, whether a set of one or more translation delivery criteria is satisfied for the language content; and,
in accordance with a determination that the set of one or more translation delivery criteria is satisfied for the language content, delivering a translation of the language content, wherein the translation is in a second language different from the first language.
